(19) United States
(12) Patent Application Publication
(10) Pub. No.: US 2009/0084904 A1
(43) Pub. Date: Apr. 2, 2009

(54) Wingtip Feathers, Including Paired, Fixed Feathers, and Associated Systems and Methods

(75) Inventor: Bruce R. Detert, Seattle, WA (US)

Correspondence Address: PERKINS COIE LLP (BOEING), P.O. BOX 1247, PATENT - SEA, SEATTLE, WA, 98111-1247, US

(73) Assignee: The Boeing Company, Chicago, IL (US)

(21) Appl. No.: 11/866,209

(22) Filed: Oct. 2, 2007

(51) Int. Cl. B64C 23/06; B64C 23/04

(52) U.S. Cl. 244/199.4

(57) ABSTRACT

Wingtip feathers, including paired, fixed features, and associated systems and methods are disclosed. A method for designing an aircraft wing in accordance with a particular embodiment includes providing a geometry for a wing having an upper surface, a lower surface, and an aft-swept wing leading edge. The method can further include selecting a geometry and location for a first feather and a second feather, based at least in part on a predicted effect of the feathers on a location of a shock at the upper surface of the wing at transonic flight conditions, with the first feather being positioned at an outboard tip of the wing and the second feather being positioned at the outboard tip of the wing aft of the first feather.

### TECHNICAL FIELD

The present disclosure is directed generally to wingtip feathers, including paired, fixed feathers, and associated systems and methods for designing and operating such systems.

### BACKGROUND

A significant amount of design and manufacturing effort goes into selecting the shape and configuration of the wings used for commercial transport aircraft. The wings must meet a myriad of design goals, including producing high lift with low drag, and providing sufficient structure to carry a payload, without contributing unnecessarily to aircraft weight. To meet these often contradictory design requirements, designers have developed a number of techniques for distributing the load over the span of the wing in a manner that produces sufficient lift without requiring unnecessary structure. For example, the “ideal” load distribution for a flat wing is generally elliptical. However, conventional aircraft wings are typically not designed for elliptical span loads. Instead, they are designed with compromised “triangular” span loads that reduce structural bending loads at the root of the wing. Such designs trade a slight increase in induced drag for a reduction in airframe weight. The degree of compromise varies considerably from one aircraft to another.

Despite the success of designers in developing highly efficient swept wing configurations for transonic commercial transport aircraft, aircraft manufacturers are under continual pressure to improve the efficiency of such wings so as to reduce aircraft fuel consumption and increase aircraft payload. One approach to improving wing performance has been to add wingtip devices. For example, several existing commercial transport aircraft include winglets extending vertically or generally vertically upwardly and/or downwardly from the tips of the wings. Another approach to enhancing lift at the wingtips is to include wingtip feathers. These feathers are typically movable in some fashion relative to the tip of the wing, and typically include a multitude of spaced-apart feather elements. While such designs have proved suitable in some installations, there is a continued need to develop low-cost, low-weight, high-efficiency designs that are suitable for commercial transport aircraft.

### SUMMARY

Aspects of the present disclosure are directed to methods associated with wings and wingtip feathers. One method for designing an aircraft wing includes providing a geometry for a wing having an upper surface, a lower surface, and an aft-swept wing leading edge. The method further includes selecting a geometry and location for a first feather and a second feather based at least in part on a predicted effect of the feathers on a location of a shock on the upper surface of the wing at transonic flight conditions, with the first and second feathers being positioned at an outboard tip of the wing, and with the second feather being positioned aft of the first feather.

In a particular embodiment, the geometry of the wing, or the first feather, or both, can be altered to change the location of the shock. In another particular embodiment, the location of the shock can be shifted aft by shifting the trailing edge of the first feather aft. In yet further embodiments, the feathers can be selected to have particular geometric characteristics. For example, the first and second feathers can be fixed relative to the wing. In another example, the outboard portion of the wing can have a wingtip with a tip chord length, and the first feather can be selected to have a first chord length that is at least 50% of the tip chord length. The first feather can also be swept aft by a first sweep angle that is equal to or greater than the wing sweep angle, and can be canted upwardly relative to the horizontal by an angle of about 45 degrees. The second feather can have a second leading edge that is swept aft by a second sweep angle greater than the first sweep angle, and is canted downwardly relative to the horizontal by an angle of about 45 degrees.

Further particular embodiments are directed to methods for operating an aircraft. One such method in accordance with a particular embodiment includes flying a swept wing commercial transport aircraft at a transonic Mach number, and forming a shock at an upper surface of the wing. The method can further include controlling a location of the shock via a first feather fixed relative to the wing at an outboard tip of the wing, and a second feather fixed at the outboard tip of the wing and positioned aft of the first feather.

### BRIEF DESCRIPTION OF THE DRAWINGS

FIG. 1 is a partially schematic, rear isometric view of a system that includes an aircraft having wing tip feathers configured in accordance with an embodiment of the disclosure.

FIG. 2 is a partially schematic, front elevation view of an embodiment of the aircraft shown in FIG. 1.

FIG. 3 is a rear elevation view of the tip region of an aircraft wing configured in accordance with an embodiment of the disclosure.

FIG. 4 is a top plan view of the outboard portion of the wing shown in FIG. 3.

FIG. 5 is a flow diagram illustrating a process for designing a wing having wing tip feathers in accordance with an embodiment of the disclosure.

### DETAILED DESCRIPTION

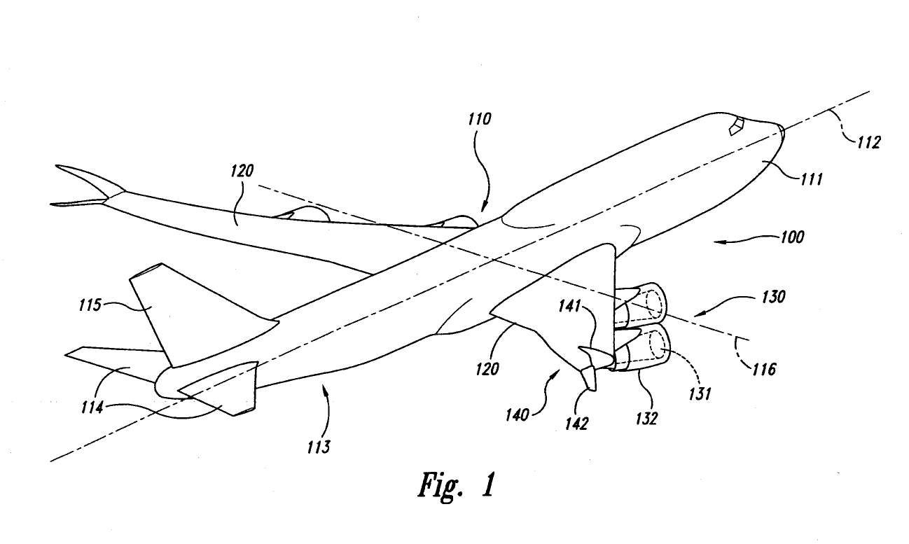

The following description is directed generally to wingtip feathers for aircraft, including tip feathers that are paired and fixed relative to the aircraft, and associated systems and methods including methods for designing and operating such systems. Several of the details describing structures and/or processes that are well-known and often associated with aspects of the systems and methods are not set forth in the following description for purposes of brevity. Moreover, although the following disclosure sets forth several representative embodiments, several other embodiments can have configurations and/or components different than those described in this disclosure. For example, other embodiments may have additional elements, and/or may delete several of the elements described below with reference to FIGS. 1-5.

FIG. 1 is a partially schematic, rear isometric illustration of an overall system 100 that includes an aircraft 110 configured in accordance with a particular embodiment. The aircraft 110 can include a fuselage 111 elongated along a body axis 112, and wings 120 carried by the fuselage. The wings 120 and the fuselage 111 can roll about the body axis 112 and pitch about a pitch axis 116. The aircraft 110 can further include an empennage 113 carrying horizontal stabilizers 114 and a vertical stabilizer 115 for stability and control in the pitch and yaw directions. A propulsion system 130 provides propulsive force for the aircraft 110 via turbofan engines 131 carried by nacelles 132. The nacelles 132 can be carried by the wings 120 as shown in FIG. 1, and/or by other portions of the aircraft 110, including the fuselage 111. While a four-engine jet aircraft is shown in FIG. 1 for purposes of illustration, aspects of the present disclosure can be applied to aircraft having other configurations, including twin engine configurations, non-turbofan engines, and/or other wing shapes.

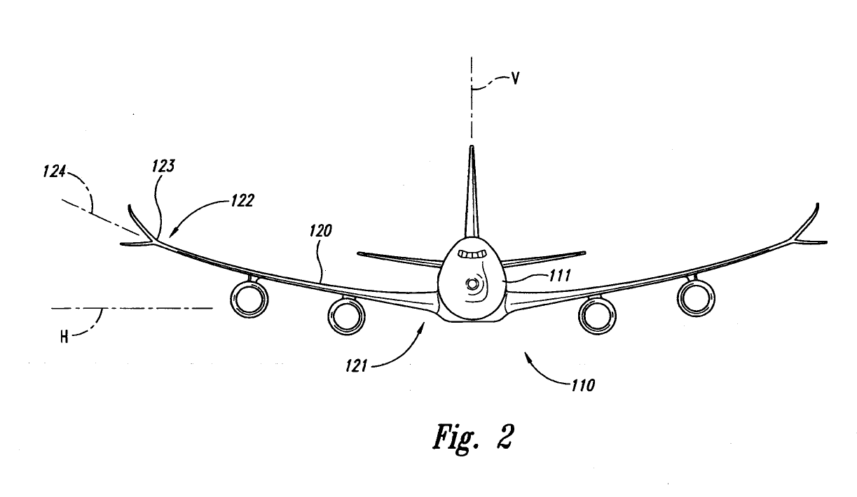

Each of the wings 120 can include a feather system 140. The feather system 140 can in turn include a first, e.g., forward feather 141 and a second, e.g., aft feather 142, both of which can be fixed relative to the wing 120. The fixed positions of the first and second feathers 141, 142, and the presence of only two feathers at each wing 120 can simplify the design, installation and operation of the feather system 140. Further aspects of the feather system 140 that improve overall aircraft performance are described further below with reference to FIGS. 2-4.

FIG. 2 is a front elevation view of the aircraft 110 shown in FIG. 1, illustrating the location of each of the wings 120 relative to the horizontal axis H and vertical axis V. Each wing 120 includes an inboard portion 121 at which the wing 120 is connected to the fuselage 111, and an outboard portion 122 positioned outwardly from the fuselage 111 in a spanwise direction. The outboard portion 122 includes a tip 123 which may be canted upwardly from the horizontal axis H in a wingtip plane 124. The first and second feathers 141, 142, which are generally carried at the tip 123, can have particular positions and orientations relative to the horizontal axis H and/or the wingtip plane 124, with these features expected to provide enhanced performance benefits for the aircraft 110.

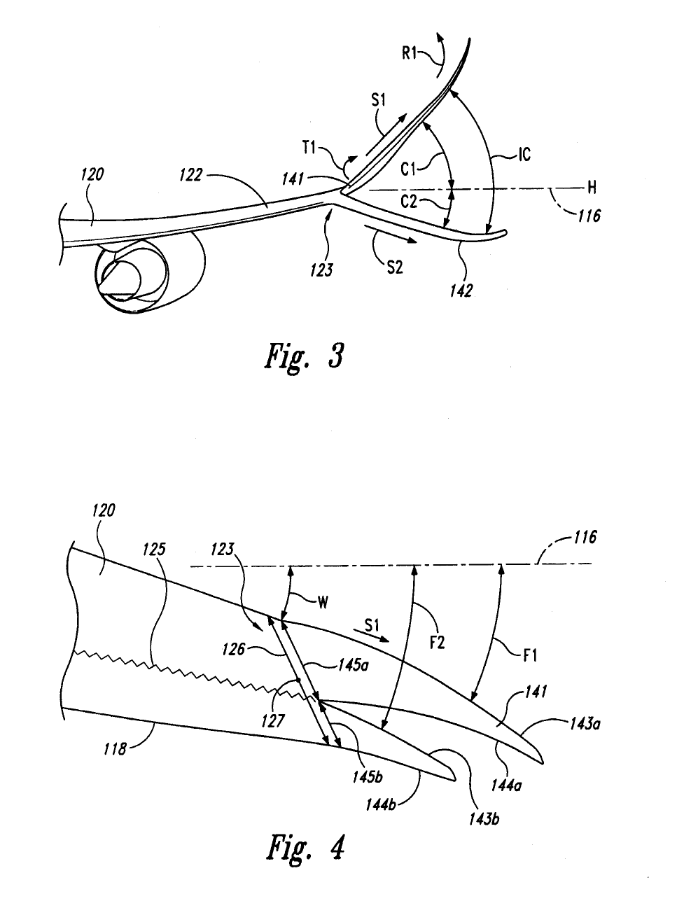

FIG. 3 is a rear elevation view of the outboard portion 122 of the right wing 120 shown in FIGS. 1 and 2. As shown in FIG. 3, the first feather 141 is canted upwardly relative to the horizontal axis H by a first cant angle C1, and the second feather 142 is canted downwardly relative to the horizontal axis H by a second cant angle C2. Each of the cant angles C1, C2 can have a value of up to about 60°, depending upon the particular embodiment. In an embodiment shown in FIG. 3, the first cant angle C1 has a value of about 45° (measured to the midpoint of the leading edge of the first feather 141), and the second cant angle C2 has a value of about 20° (measured to the midpoint of the leading edge of the second feather 142). The included cant angle IC between the first feather 141 and the second feather 142 can have a value of from about 30° to about 120°. In a particular embodiment shown in FIG. 3, the included cant angle IC has a value of about 65°. By keeping the included cant angle greater than 30°, the likelihood for interference between the two feathers 141, 142 can be reduced, and the likelihood for channel or corner flow to develop at or near the junction between the two feathers 141, 142 can also be reduced. By keeping the feathers 141, 142 canted outwardly rather than inwardly relative to the wing 120, the likelihood for channel flow and/or other flows interfering with the wing 120 can also be reduced.

In a particular embodiment, both the first and second tip feathers 141, 142 can be flat and can accordingly define a plane having a fixed angular value relative to the horizontal H. In other embodiments, the tip feathers 141, 142 can have other shapes that are expected to improve the aerodynamic performance of these surfaces. For example, the first feather 141 can be twisted in a spanwise direction S1, as indicated by arrow T1. In addition to or in lieu of twisting the first feather 141, the first feather 141 can be rolled toward its outboard tip, as indicated by arrow R1. The second feather 142 can also be twisted in a manner that changes along its span, as indicated by arrow S2, and/or can also be rolled toward its outboard tip. It is expected that these arrangements will improve the aerodynamic performance of both the first and second tip feathers 141, 142. For example, the twist provided to both the tip feathers 141, 142 can allow the feathers to operate a higher angles of attack without stalling, as compared with feathers that are untwisted.

FIG. 4 is a top plan view of the right wing 120 described above with reference to FIG. 3. As shown in FIG. 4, the tip 123 of the wing 120 has a wing sweep angle W relative to the wing pitch axis 116. The first feather 141 can have a first feather leading edge 143a that is swept by at least the same amount as the wing sweep angle W. For example, the first feather leading edge 143a can have a first feather sweep angle F1 that gradually increases beyond the wing sweep angle W in a spanwise direction S1, when viewed directly from above. The second feather 142 can have a second feather leading edge 143b that is swept by an angle F2 that is also equal to or greater than the wing sweep angle W. It is expected that the increased leading edge sweep angles of the first and second feathers 141, 142, and more particularly the first feather 141, can improve the aerodynamic performance of the feather system 140. For example, the increased sweep angles can reduce pressure peaks at the feather leading edges, which can allow higher angles of attack with a reduced likelihood for flow separation and stall, e.g., at low speed conditions. In addition, the leading edges of the feathers 141, 142 may be relatively blunt, and the increased aft sweep can lower the shock strength at the feathers (e.g., at high speed conditions).

Each of the first and second feathers 141, 142 can have a chord length that is selected to improve aerodynamic performance, not only of the feathers but also of the wing 120 from which the feathers depend. For example, the wingtip 123 can have a wingtip chord length 126, and the first feather 141 can have a first feather chord length 145a that is at least 50% of the wingtip chord length 126. Accordingly, the juncture between the first feather trailing edge 144a and the wing tip 123 can be at or aft of a midchord point 127 of the wingtip 123. It is expected that this arrangement will control the location of a shock 125 (shown schematically) that forms on the upper surface of the wing 120 at transonic Mach numbers. In particular, it is expected that by placing the first feather trailing edge 144a aft of the midchord point 127, the shock 125 will tend to “follow” the first feather trailing edge 144a over at least a spanwise portion of the wing 120. Accordingly, it is expected that the shock 125 will be aft of a location it would otherwise be were the first feather 141 to have a chord length 145a less than 50% of the wingtip chord length 126. An expected advantage of this arrangement is that it can keep the shock 125 at an aft location over the outboard portion 122 of the wing 120. Because the pressure of air passing through the shock 125 increases, moving the position at which this increase occurs in an aft direction reduces the amount of wing area subjected to the elevated pressure and therefore can reduce the expected impact on wing lift created by the presence of the shock 125.

In a particular embodiment, the second feather 142 can have a second feather chord length 145b that complements the first feather chord length 145a, e.g., the first and second feather chord lengths 145a, 145b can add up to the wingtip chord length 126. As a result, the second feather trailing edge 144b can be aligned with the wing trailing edge 128. In other embodiments, the trailing edge of the second feather 142 need not be coincident with the trailing edge 128 of the wing 120. However, it is expected that in at least some embodiments, coincident trailing edges will reduce the likelihood for the formation of vortices or other flow disturbances at the trailing edge region.

One feature of at least some of the foregoing embodiments described above with reference to FIGS. 1-4 is that the feather system may include only two feathers attached to each of the wings 120. An expected advantage of this arrangement is that the feathers can be easier to install, and the likelihood for interference between the feathers can be reduced. A further advantage of this arrangement is that it more easily allows for a leading feather (e.g., first feather 141) to have a chord length that is at least 50% of the wing chord length at the tip. As discussed above, an expected advantage of this arrangement is that it can keep the shock on the wing upper surface in an aft position so as to reduce the impact of the pressure increase through the shock on the overall lift of the wing.

Another feature of at least some of the foregoing embodiments is that both the first and second feathers 141, 142 are fixed relative to the wing 120, and neither the first feather 141 nor the second feather 142 includes movable high lift devices (e.g., trailing edge flaps, leading edge slats, movable sub-winglets, or other such features). An expected advantage of this arrangement is that it can simplify both the installation and maintenance of the feather system 140. Another expected advantage is that the feathers can be designed to have a particular orientation relative to the wing 120, and that orientation can remain fixed over the entire operating envelope of the aircraft, thereby reducing the likelihood for the feathers to be placed in a less than optimum position.

Methods in accordance with particular embodiments of the disclosure include designing the location and position of the wing 120 and the first and second feathers 141, 142 in conjunction with each other and possibly in an iterative fashion. For example, with a given wing geometry, the size, shape and location of the first and second feathers can be selected in an iterative manner to provide the desired shock location. In another embodiment, the first and second feathers can have a fixed geometry and the outboard portion of the wing can be tailored to produce the desired shock location. In still a further embodiment, the size, shape, and location of the first and second feathers 141, 142, as well as portions of the wing 120 (e.g., the outboard portion) can be changed in an iterative manner until the desired position of the upper surface wing shock is achieved.

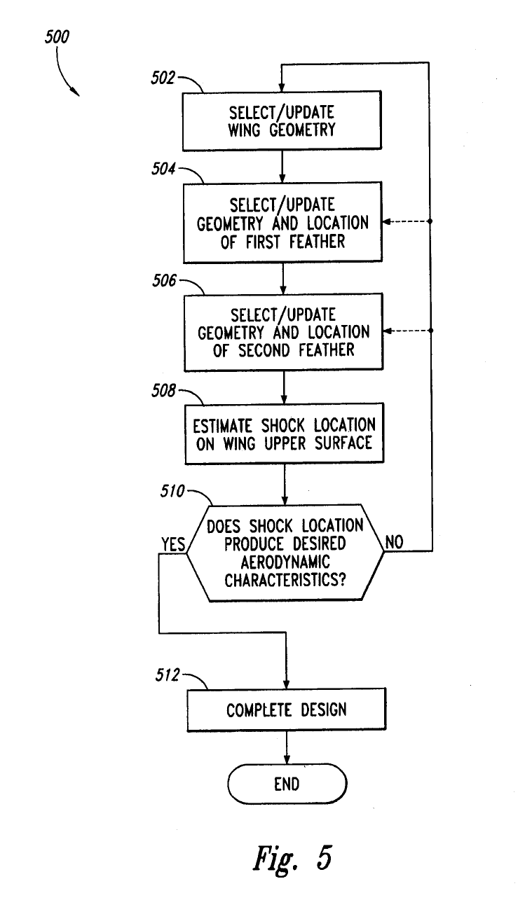

FIG. 5 is a flow diagram illustrating a representative methodology for arriving at a wing system in accordance with a particular embodiment. The method 500 can include selecting or updating a wing geometry (process portion 502). For example, process portion 502 can include establishing a baseline wing geometry based on the aircraft mission requirements. In process portion 504, the geometry and location of a first wing tip feather are selected or updated. For example, process portion 504 can include establishing a baseline first feather geometry and location. In process portion 506, the location and geometry of the second wing tip feather are selected or updated.

After process portions 502-506 have been completed, the wing with the first and second feathers can be analyzed. For example, process portion 508 can include estimating the location of a shock on the wing upper surface based upon the foregoing geometry. The aerodynamic characteristics associated with the shock location can be compared with target values in process portion 510. The desired aerodynamic characteristics can include lift/drag characteristics, vortex formation characteristics, and/or other parameters. If the shock location produces the desired aerodynamic characteristics (as determined in process portion 510), then the design of the wing and wing tip feathers can be completed in process portion 512. If the desired aerodynamic characteristics are not met in process portion 510, the process can return to process portion 502, process portion 504 or process portion 506. For example, if the wing geometry is to remain fixed, the geometry and/or location of the first feather and/or the second feather can be updated in process portions 504 and 506 respectively. If the wing geometry is variable, it can be changed in process portion 502. The geometry and/or location of any combination of the wing, the first feather, and the second feather can be varied in an iterative manner until the expected shock location produces the desired aerodynamic characteristics.

In still a further particular embodiment, aspects of the process 500 can be automated. For example, one or more of the parameters described above (e.g., feather chord length, twist angle, roll-up characteristics, and/or other features) can be parametrically varied using a computer simulation. For example, the chord length of the first feather and the associated location of the first feather trailing edge is expected to have a significant effect on the location of the shock on the upper surface. Accordingly, a computer simulation can include parametrically varying the chord length and trailing edge location and automatically selecting the chord length and trailing edge location that produces the desired shock location. Similar techniques can be used to optimize other characteristics and features of the wing tip feathers and/or the wing (in particular the outboard portion of the wing) to which the feathers are attached.

Suitable analysis tools for conducting the foregoing methods include AGPS, a computer-aided-design geometry generation tool available from The Boeing Company of Chicago, Ill. The TRANAIR code, available from Calmer Research Corp. of Cato, N.Y., can be used to perform flow analysis. The NPSOL code, available from Stanford Business Software, Inc. of Palo Alto, Calif. and/or TRANAIR can be used to optimize the geometry based on flow results. Other suitable tools can be used in other embodiments.

From the foregoing, it will be appreciated that specific embodiments of the disclosure have been described herein for purposes of illustration, but that various modifications may be made without deviating from these embodiments. For example, the tip feathers can have different shapes and/or orientations than are not specifically shown in the Figures, while still being arranged in pairs that are fixed relative to the wing and/or that control the wing upper surface shock generally in the manner described above. In still further embodiments, the tip feathers may in some cases be movable relative to the wing from which they depend, while still providing the shock-positioning features described above. Certain aspects of the foregoing embodiments described in the context of particular embodiments may be combined or eliminated in other embodiments. For example, a particular embodiment may include a first feather that is not swept by an angle greater than the wing sweep angle, but that still has a chord length that extends beyond the mid-chord point of the wingtip, so as to provide control over the wing upper surface shock. Further, while advantages associated with certain embodiments have been described in the context of those embodiments, other embodiments may also exhibit such advantages, and not all embodiments need necessarily exhibit such advantages. Accordingly, the disclosure can include other embodiments not shown or described above.

We claim:

1. A method for designing an aircraft wing, comprising:
providing a geometry for a wing having an upper surface, a lower surface, and an aft-swept wing leading edge; and
selecting a geometry and location for a first feather and a second feather, based at least in part on a predicted effect of the feathers on a location of a shock at the upper surface of the wing at transonic flight conditions, the first feather being positioned at an outboard tip of the wing, and the second feather being positioned at the outboard tip of the wing aft of the first feather.

2. The method of claim 1, further comprising altering the geometry of the wing to change the location of the shock.

3. The method of claim 1, further comprising altering at least one of the geometry and the location of the first feather to change the location of the shock.

4. The method of claim 1 wherein selecting a geometry and location includes selecting a location of a trailing edge of the first feather.

5. The method of claim 1 wherein the outboard tip of the wing has a tip chord length, and wherein selecting a geometry and location includes selecting a root chord length of the first feather to have a value of at least 50% of a tip chord length of the wing.

6. The method of claim 1, further comprising shifting a location of the shock on the upper surface from a first position to a second position aft of the first position by moving a trailing edge location of the first feather in an aft direction.

7. The method of claim 1 wherein the outboard tip of the wing has a tip chord length, and wherein selecting a geometry and location includes:
selecting the first feather to have a first chord length that is at least 50% of the wing chord length, a first leading edge that is swept aft by an amount greater than the sweep of the wing leading edge, and an upward cant angle of about 45° relative to horizontal; and
selecting the second feather to have a second leading edge that is swept aft by an amount greater than the sweep of the first leading edge, and an included cant angle between the first and second feathers of at least 65°.

8. The method of claim 1 wherein selecting a geometry and location for a first feather and a second feather includes selecting the first and second feathers to have fixed geometries.

9. The method of claim 1 wherein selecting a geometry and location for a first feather includes selecting the first feather to have a first leading edge that is swept aft by a first sweep angle that is equal to or greater than a sweep angle of the wing leading edge.

10. The method of claim 9 wherein selecting a geometry and location for a second feather includes selecting the second feather to have a second leading edge that is swept aft by a second sweep angle that is equal to or greater than the first sweep angle.

11. The method of claim 1 wherein selecting a geometry and location for a first feather and a second feather includes selecting the first feather to be canted upwardly relative to horizontal, and selecting the second feather to be canted downwardly relative to horizontal.

12. The method of claim 1 wherein selecting a geometry and location for a first feather and a second feather includes selecting the first and second feathers to be twisted and rolled upwardly in an outward spanwise direction.

13. The method of claim 1 wherein selecting a geometry and location for a first feather and a second feather includes selecting neither the first feather nor the second feather to include a deployable variable geometry device.

14. A method for designing an aircraft wing, comprising:
selecting geometries and locations for a wing, a first feather, and a second feather in an iterative manner based at least in part on a predicted effect of the first and second feathers on a location of a shock at an upper surface of the wing at a transonic flight condition, the first feather being positioned at an outboard tip of the wing, and the second feather being positioned at the outboard tip of the wing aft of the first feather.

15. The method of claim 14 wherein the outboard tip of the wing has a tip chord length, and wherein selecting geometries and locations for the first and second feathers includes:
selecting the first feather to have a first chord length that is at least 50% of the wing chord length, a first leading edge that is swept aft by an amount greater than the sweep of the wing leading edge, and an upward cant angle of about 45° relative to horizontal; and
selecting the second feather to have a second leading edge that is swept aft by an amount greater than the sweep of the first leading edge, and an included cant angle between the first and second feathers of at least 65° relative to horizontal.

16. The method of claim 14 wherein selecting geometries and locations includes selecting a location of a trailing edge of the first feather.

17. The method of claim 14 wherein selecting geometries and locations includes selecting a root chord length of the first feather to have a value of at least 50% of a tip chord length of the wing.

18. The method of claim 14 wherein selecting geometries and locations includes selecting the first and second feathers to be twisted and rolled upwardly in an outward spanwise direction.

19. The method of claim 14, further comprising shifting a location of the shock on the upper surface from a first position to a second position aft of the first position by moving a trailing edge location of the first feather in an aft direction.

20. A method for operating an aircraft, comprising:
flying a swept wing commercial transport aircraft at a transonic Mach number;
forming a shock at an upper surface of the wing; and
controlling a location of the shock via a first feather fixed relative to the wing at an outboard tip of the wing, and a second feather fixed at the outboard tip of the wing and positioned aft of the first feather.

21. The method of claim 20 wherein controlling a location of the shock includes controlling the location of the shock without the use of any active control surfaces at the first and second feathers.

22. The method of claim 20 wherein the wing has a wing tip with a wing tip chord, and wherein controlling a location of a shock includes controlling a location of a shock with a trailing edge of the first feather having a fixed location at or aft of a midpoint of the wing tip chord.

23. The method of claim 20 wherein controlling a location of a shock includes controlling the location of the shock with a first feather that is twisted and rolled upwardly in a spanwise outward direction.
